(19) United States
(12) Patent Application Publication
(10) Pub. No.: US 2005/0035651 A1
(43) Pub. Date: Feb. 17, 2005

(54) Non-rotating display wheel cover

(76) Inventor: Leslie Hsiao, Orlando, FL (US)

Correspondence Address: Charles J. Prescott, P.A., Suite 115, 2033 Wood Street, Sarasota, FL, 34237, US

(21) Appl. No.: 10/641,602

(22) Filed: Aug. 15, 2003

(51) Int. Cl. B60B 7/04

(52) U.S. Cl. 301/37.25

(57) ABSTRACT

A display wheel cover assembly connectable to a rotatable wheel of a vehicle. This invention includes a cup-shaped inner member having mounting flanges which are rigidly connectable to the wheel by the wheel lug bolts or studs. A wheel cover includes an elongated support shaft rotatably supported for rotation in a support bearing member mounted coaxially with the wheel cover. A locking member attached to the first end of the support shaft prevents withdrawal of the support shaft from the support bearing member. A second end of the support shaft is rigidly or threadably connected to and in coaxial alignment with the central or bottom portion of the cup-shaped inner member. A counterweight attached to the wheel cover prevents rotation of the wheel cover which is adapted for interchangeable display indicia to be attached thereto.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to automotive wheel covers, and more particularly to a commercial display wheel cover including a replaceable display disc which remains substantially stationary with respect to the vehicle while the vehicle is moving.

2. Description of Related Art

The central outer portion of a vehicle wheel, being fully viewable while the vehicle is in motion, provides an opportunity for the placement of readable graphics in this otherwise merely decorative or unornamental portion of the wheel of larger utility vehicles such as buses or trucks. The utilization of this otherwise merely unadorned space is contingent upon the readability of graphics and word messages being held relatively stationary with respect to the vehicle in motion.

A number of prior art patented inventions address this display and advertising opportunity.

In U.S. Pat. No. 5,659,989, Hsiao teaches a wheel cover which includes an outer disc member which is rotatably mounted to an inner base member so that the display indicia applied to the disc member will remain substantially rotation free under vehicle movement. This disclosure includes stabilizing structure to maintain alignment and restrict oscillation of the outer disc member bearing the viewable indicia thereon.

Boothe, in U.S. Pat. No. 5,957,542 discloses a theft-proof, non-rotational wheel cover with replaceable ornamental outer surface. This arrangement relies upon and is engageable within the central cavity of the automotive wheel.

Another advertising display device for a vehicle wheel is disclosed by Ryan in U.S. Pat. No. 2,548,070. In this arrangement, however, the device is adapted for attachment to a non-rotatable axle of the motor vehicle.

In U.S. Pat. No. 2,869,262, Lucas teaches another wheel-supported advertising sign arrangement which appears to attach in rotatable fashion to the outer hubcap of the wheel assembly.

In the disclosure of Kovalenko, in U.S. Pat. No. 4,280,293, a stationary display member is attachable to the vehicle hub and utilizes a flowable material such as mercury acting upon veins within a chamber of the device to substantially eliminate rotation of the bearing-mounted outer display member.

A non-rotating wheel cover assembly shown in U.S. Pat. No. 5,588,715 invented by Harlen teaches yet another wheel cover assembly which is attachable to the outer end of an axle by separate bracketry to support the bearing mounted display member. A thickened lower portion of the wheel cover provides sufficient counterbalance to inhibit or prevent rotation of the display cover while the vehicle is in motion.

Matsushita discloses a free wheel cap in U.S. Pat. No. 4,678,239 which teaches a non-rotating wheel cover having a counterbalanced disc-like body which is bearing connected to an inner multi-arm structure having spring-like clips connected at the outer periphery of the device which interengage with the wheel rim.

Another wheel cover was invented by Okamoto and disclosed in U.S. Pat. No. 6,120,104 teaching a flexible side feature connected to the center of the wheel in support of a display wheel cover. An air current guide is formed into the display cover which assists in stabilizing the display portion without substantial rotational movement as the vehicle is moving.

Other prior art devices which teach vehicle wheel display covers are as follows:
U.S. Pat. No. 710,195 to Jones
U.S. Pat. No. 2,014,058 to Tonai
U.S. Pat. No. 2,169,237 to Gasco
U.S. Pat. No. 4,781,419 to Boothe
U.S. Pat. No. 5,190,354 to Levy
U.S. Pat. No. 5,490,342 to Ruterman

Another recent invention in U.S. Pat. No. 6,536,848 discloses a display wheel cover which is substantially non-rotating with respect to the vehicle when in motion and which utilizes a unique inner member having an elongated hat-shaped section that facilitates attachment to the rim of the wheel by threadably adjustable rim-engaging members that align into the concave groove formed in the outer wheel rim. A unique cam-locking device both retains the outer display wheel cover in place and also prevents its theft removal as a separate security feature requiring a special tool for removal.

### BRIEF SUMMARY OF THE INVENTION

This invention is directed to a display wheel cover assembly connectable to a rotatable wheel of a vehicle. This invention includes a cup-shaped inner member having mounting flanges which are rigidly connectable to the wheel by the wheel lug bolts or studs. A wheel cover includes an elongated support shaft supported for rotation in a support bearing member mounted in coaxial alignment in the wheel cover. A locking member attached to the first end of the support shaft prevents withdrawal of the support shaft from the support bearing member. A second end of the support shaft is rigidly or threadably connected to, and coaxially with, the central portion of the inner member. A counterweight attached to the wheel cover prevents rotation of the wheel cover which is adapted for interchangeable display indicia to be attached thereto.

It is therefore an object of this invention to provide a non-rotating wheel cover for a lighter duty vehicle or automobile which will facilitate the application of decorative and readable commercial display indicia such as in advertising while the vehicle is moving.

It is yet another object of this invention to provide an advertising display cover for the wheel of an automobile which is easily interchangeable.

In accordance with these and other objects which will become apparent hereinafter, the instant invention will now be described with reference to the accompanying drawings.

### BRIEF DESCRIPTION OF THE SEVERAL VIEWS OF THE DRAWING(S)

FIG. 1 is an exploded perspective view of one embodiment of the invention.

FIG. 2 is a cross section view of the invention shown in FIG. 1 as assembled.

FIG. 3 is an end elevation view of the wheel-facing surface of a second embodiment of the invention.

FIG. 4 is a longitudinal section view through the embodiment of the invention of FIG. 3.

FIG. 5 is an elevation view of the locking member shown in FIG. 4.

### DETAILED DESCRIPTION OF THE INVENTION

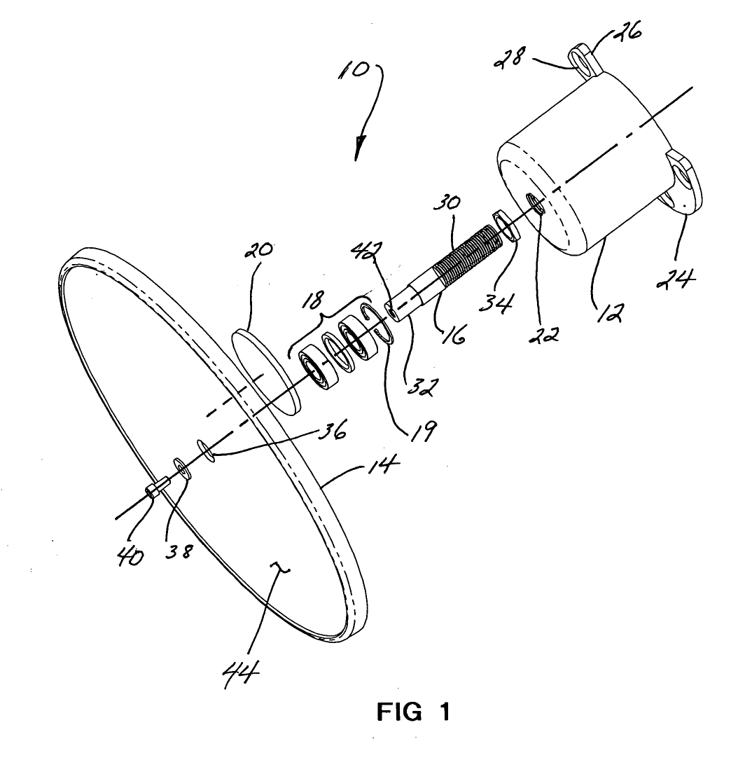

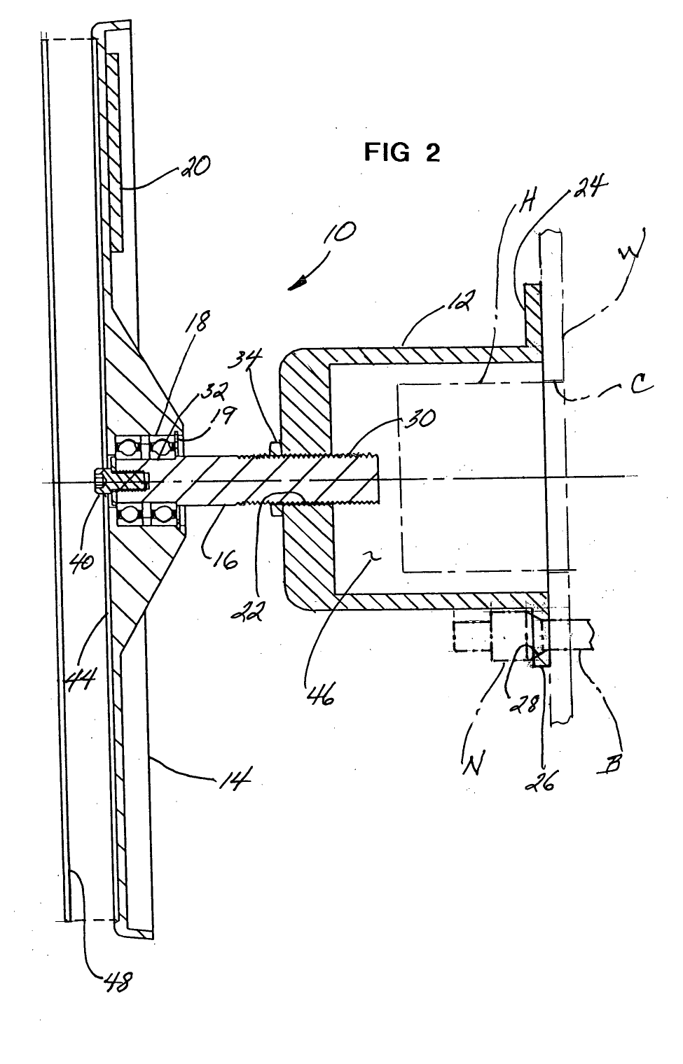

Referring now to the drawings, one embodiment of the invention is there shown in FIGS. 1 and 2 at numeral 10. This embodiment 10 is attachable to a wheel W of a light duty vehicle (shown in broken phantom) such as an automobile. This wheel cover 10 includes an inner cup-shaped hub 12, a circular or disc-shaped wheel cover 14 and an elongated support shaft 16.

The inner cup-shaped member 12 includes mounting flanges 24 and 26 each of which include at least one bolt hole 28 adapted for interconnection to one of the several threaded studs B of the wheel W by tightening engagement of a lug nut N. Each of the bolt holes 28 is tapered to match the taper of each of the lug nuts N. The cup-shaped configuration of the inner member 12 is provided for clearance around a bearing cap or protective cup H (in phantom) typically associated with axle wheel bearings (not shown).

The support shaft 16 is threaded on one end thereof at 30 for threadable engagement into a mating threaded aperture 22 formed coaxially with the center line of the inner member 12. The length of the threads 30 being greater than threads 22 permits the spacing between the wheel W and the wheel cover 14 to be adjusted as desired and then secured by a jam nut 34.

The outer end 32 of the support shaft 16 is engaged within a set of bearings 18 which are secured within a mating circular cavity formed into the central portion of the wheel cover 14. A retaining clip 19 secures the bearing arrangement 18 in the position shown in FIG. 2 while a threaded fastener 40 having an enlarged head is threadably engaged into a longitudinal threaded cavity 42 of the support shaft 16 which secures the wheel cover 14 in coaxial fully engaged alignment with the cylindrical mating surface 32 of the support shaft 16.

The wheel cover 14 includes a cavity or mounting surface 44 sized to attachably receive a display member 48 bearing viewable advertising indicia thereon which is attachable against surface 44 by conventional mechanical or adhesive means. The display member 48 may bear any form of commercial advertising indicia as desired and may be replaced with another display member having a different commercial message at appropriate times. By providing a counterweight 20, the wheel cover 14 will be maintained in a substantially non-rotatable position with respect to the support shaft 16 and wheel W as the vehicle is driven. The readable indicia applied onto the display member 48 is thus maintained in a stationary upright orientation with respect to the vehicle even while the vehicle is in motion.

To highlight several aspects of this embodiment 10, to vary the lateral spacing of the wheel cover 14 from the wheel W, the threaded portion 30 of the support shaft 16 only need be adjustably repositioned within the threaded aperture 22 formed centrally into the inner member 12. By supporting the wheel cover 14 on a bearing arrangement 18 which is held supported on the outer end 32 of the support shaft 16 by fastener 40, the inertia weight and overall economy of design simplicity of this embodiment 10 is achieved. Moreover, to achieve a proper alignment of the wheel W onto the axle, not all of the threaded studs B are utilized by the present invention. In this embodiment 10, only three of the five studs B are matched to mating apertures 28 in flanges 24 and 26 as previously described. The two remaining studs B are utilized to first align the wheel W by installing the corresponding lug nuts N prior to attachment of the inner member 12. Thereafter, the remaining lug nuts N are utilized to properly center the inner hub 12 with respect to the rotational axis of both the axle (not shown) and the wheel W to the support shaft 16 and wheel cover 14.

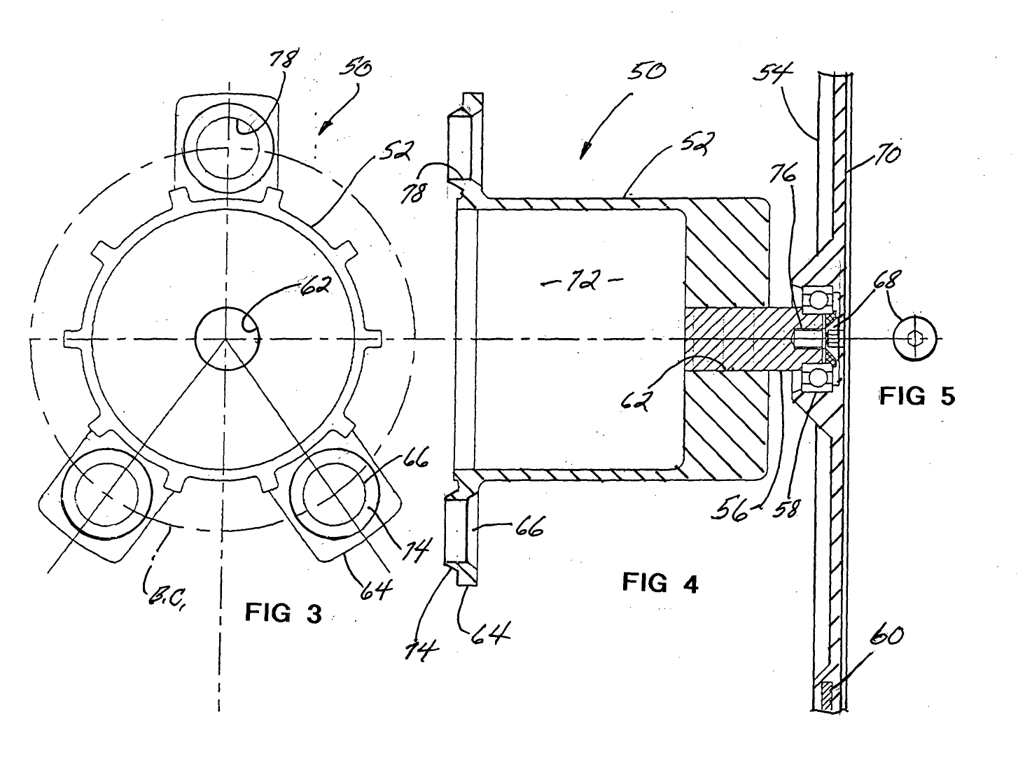

Referring now to FIGS. 3 to 5, another embodiment of the invention is there shown generally at numeral 50. This embodiment 50 also includes a cup-shaped inner member 52 providing axle hub clearance and having spaced mounting flanges 64 which are spaced and adapted to be supportively attached to three of the five wheel mounting studs (not shown) through aligned mounting holes 66 as previously described. These mounting holes 66 properly coaxially align the inner member 52 to the axle axis by providing outer tapered surfaces 74 for proper alignment. These tapered alignment portions 74 mate within the tapered holes formed into the wheel (not shown) where more critical alignment of the inner member 52 with respect to the axel concentricity is desired.

This embodiment 50 also includes an elongated support shaft 56 which is press fit into a suitably sized longitudinal coaxially aligned aperture or bore 62. The opposite end of the support shaft 56 is held within a bearing 58 which is mounted securely within a wheel cover 54 at its enlarged central portion thereof. An enlarged headed threaded fastener 68 secures this arrangement of the support shaft 56 lockably engaged for rotation within bearing 58 which, in turn, is held within the central enlarged portion of the wheel cover 54.

Again, a cavity 70 is sized to receive a display member (not shown) which is easily interchangeable as desired. A counterweight 60 maintains the wheel cover 54 in a non-rotating upright orientation as the vehicle is moved and the inner hub 52, connected to the wheel (not shown) is rotated.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A display wheel cover assembly for supporting a non-rotating display indicia and connectable to a rotatable wheel of a vehicle comprising:
a cup-shaped inner member adapted for rigid connection by wheel retaining studs or bolts to the wheel and having a support shaft receiving aperture formed through a central portion of said inner member in substantially coaxial alignment with a rotational axis of the wheel;
a circular wheel cover including an elongated support shaft having a first end thereof held for rotation only by a bearing support connected concentrically to said wheel cover;
a second end of said support shaft connected in longitudinally adjustable coaxial alignment with said aperture;
a locking member connectable to said first end of said support shaft, said locking member preventing withdrawal of said support shaft from said support bearing member, thus locking said inner member and said wheel cover together for relative rotation only therebetween;
a counterweight attached to said wheel cover to substantially prevent rotation of said wheel cover with respect to the vehicle as the wheel is rotated during vehicle movement;
an interchangeable display indicia attached to an outer surface of said wheel cover which remains substantially upright and readable during vehicle movement.

2. A display wheel cover as set forth in claim 1, wherein:
said inner member includes a limited number of mounting holes which are aligned with only a portion of wheel retaining studs or bolts and mating tapered wheel mounting holes whereby the wheel may be aligned and secured to an axle of the vehicle by installation of lug nuts thereto before attachment of said inner member.

3. A display wheel cover as set forth in claim 2, wherein:
each of said mounting holes includes an outer tapered surface similar to that of a lug nut whereby said outer tapered surfaces mate and align with the tapered wheel mounting holes.

4. A non-rotating display wheel cover assembly connectable to a rotatable wheel of a vehicle comprising:
an inner member having a central portion outwardly offset outwardly from a plane lying in an outer annual peripheral portion of said inner member, said inner member rigidly connectable to the wheel by wheel lugs which also retain the wheel against an axle of the vehicle, said inner member also having a support shaft mounting aperture formed centrally through said central portion of said inner member in substantially coaxial alignment with a rotational axis of the wheel;
a circular wheel cover including a central bearing member and an elongated support shaft supportedly held for rotation only in said bearing member;
said support shaft having a threaded first end threadably engaged into said shaft mounting aperture prevents withdrawal of said support shaft from said support bearing member, thus locking said inner member and said wheel cover together for relative rotation only therebetween;
a counterweight attached to said wheel cover to substantially prevent rotation of said wheel cover with respect to the vehicle as the wheel is rotated during vehicle movement;
said wheel cover having an outwardly facing surface adapted to supportively receive an interchangeable display indicia attached thereto which remains substantially upright and readable during vehicle movement.

5. A display wheel cover as set forth in claim 4, wherein:
said inner member includes a limited number of mounting holes which are aligned with only a portion of wheel retaining studs or bolts and mating tapered wheel mounting holes whereby the wheel may be aligned and secured to an axle of the vehicle by installation of lug nuts thereto before attachment of said inner member.

6. A display wheel cover as set forth in claim 5, wherein:
each of said mounting holes includes an outer tapered surface similar to that of a lug nut whereby said outer tapered surfaces mate and align with the tapered wheel mounting holes.
